(19) United States
(12) Patent Application Publication
(10) Pub. No.: US 2022/0033080 A1
(43) Pub. Date: Feb. 3, 2022

(54) A PAYLOAD CONTROL DEVICE

(71) Applicant: Vestas Wind Systems A/S, Aarhus N (DK)

(72) Inventors: Ivar J.B.K. Jensen, Hornslet (DK); Niels Vinther Voigt, Aarhus N (DK); Aksel Petersen, Rinkøbing (DK); Torben Ladegaard Baun, Skødstrup (DK)

(21) Appl. No.: 17/312,696

(22) PCT Filed: Dec. 13, 2019
(86) PCT No.: PCT/DK2019/050389

§ 371 Date: Jun. 10, 2021

(30) Foreign Application Priority Data
Dec. 21, 2018 (DK) PA 2018 70856

(51) Int. Cl. B64D 1/22; B64C 39/02; B64D 1/12

(52) U.S. Cl. CPC B64D 1/22; B64C 39/024; B64C 2201/108; B64C 2201/128; B64C 2201/027; B64D 1/12

(57) ABSTRACT

A payload coupler with a position control device for controlling a position of the payload coupler when suspended from a lower end of a line for attachment at an upper end thereof to a lifting device. The payload coupler includes a payload attachment means and at least two propulsors. The payload attachment means couples to and/or decouples from a payload and is arranged to directly couple the payload coupler to a payload. The propulsors are configured to generate resultant propulsion forces which are non-parallel and having at least a component perpendicular to the axis of the line when the line is hanging taut under gravity.

### FIELD OF THE INVENTION

The present invention relates to a payload coupler, a lifting system including the payload coupler, and a method of controlling a position of a suspended payload coupler.

### BACKGROUND OF THE INVENTION

Wind turbines are regularly monitored during operation, and in some cases the wind turbines may require maintenance or the replacement of components. This can present many challenges, not least because modern wind turbines can have heights well in excess of 100 m.

Maintenance personnel may need to scale a wind turbine in order to manually inspect, repair, or replace wind turbine components. This can be an arduous process and it may not always be apparent which tools are needed prior to scaling the structure. If a tool or component is required that is not carried by the maintenance personnel, it can be difficult to obtain the tools or components and may take a long time.

Therefore, there is a need to quickly and safely deliver tools and components to target locations, particularly locations that are difficult to reach, such as on wind turbines or similar structures.

### SUMMARY OF THE INVENTION

A first aspect of the invention provides a payload coupler with a position control device for controlling a position of the payload coupler when suspended from a lower end of a line for attachment at an upper end thereof to a lifting device, the payload coupler comprising: a payload attachment means for coupling to and/or decoupling from a payload, the payload attachment means arranged to directly couple the payload coupler to a payload, and at least two propulsors, wherein the at least two propulsors are each configured to generate resultant propulsion forces which are non-parallel, each resultant force having at least a component perpendicular to the axis of the line when the line is hanging taut under gravity.

A further aspect of the invention provides a lifting system comprising: a line, a payload coupler according to the first aspect, the payload coupler coupled to the lower end of the line, and a lifting device coupled to the upper end of the line, the lifting device having a lifting device propulsion means for moving the lifting device.

A further aspect of the invention provides a method of controlling a position of a suspended payload coupler, the method comprising:
providing a payload coupler suspended from a lower end of a line which is coupled at its upper end to a lifting device, the payload coupler having a propulsor configured to generate a resultant propulsion force having at least a component perpendicular to the axis of the line when the line is hanging taut under gravity,
operating the propulsor to generate a propulsive force to maintain the payload coupler in a first stable position or to move the payload coupler along a predetermined path; and
coupling a payload to the payload coupler or decoupling a payload from the payload coupler while the payload coupler is maintained in the first stable position or moved along the predetermined path.

The invention allows a payload to be delivered to a difficult location that would be unsafe or inaccessible for a lifting device. The payload coupler can move relative to the lifting device to move a payload with high precision, and can provide stability to the payload. The lifting device can be used to provide the majority of the lifting force, whilst the line allows a safe distance to be maintained between the lifting device and a worker or structure. The payload coupler can be controlled to attach to a payload autonomously, without external assistance, by moving the payload attachment means to couple to a corresponding payload connecting means.

The components of the resultant propulsion forces perpendicular to the axis of the line when the line is hanging taut under gravity may be orthogonal.

The propulsors may each be selectively operable to generate resultant propulsion forces in two opposite directions.

The propulsors may be first propulsors and the payload coupler may further comprise two second propulsors, each second propulsor configured to generate a resultant propulsion force parallel to a resultant force generated by a respective one of the first propulsors, the respective first and second propulsors being spaced apart in a direction perpendicular to their respective resultant force.

The propulsors may be arranged to generate a resultant force perpendicular to the axis of the line when the line is hanging taut under gravity.

The propulsors may be arranged to generate a force having a component parallel to the axis of the line when the line is hanging taut under gravity.

The payload coupler may further comprise a movement sensor and a control system, the control system being coupled to the movement sensor and the propulsors, and wherein the control system is arranged to drive the propulsors to oppose movement of the device detected by the movement sensor.

The payload coupler may further comprise a position sensor and a control system, the control system being coupled to the position sensor and the propulsors, and wherein the control system is arranged to drive the propulsors to move the payload coupler to a target location.

The lifting device propulsion means may be operable independently of the propulsors.

The lifting device may comprise a power source arranged to provide power to the payload coupler.

The method of controlling a position of a suspended payload coupler may further comprise operating the propulsor to generate a propulsive force in order to move the payload coupler to a second stable position different from the first stable position.

The line may be substantially vertical when the payload coupler is in the first stable position and/or the second stable position.

The line may be non-vertical when the payload coupler is in the first stable position and/or the second stable position.

The method of controlling a position of a suspended payload coupler may further comprise coupling the payload to the payload coupler or decoupling the payload from the payload coupler while the payload coupler is in the second stable position.

The payload may be coupled to or decoupled from the payload coupler by movement along the predetermined path.

The method of controlling a position of a suspended payload coupler may further comprise operating a propulsion device of the lifting device and the propulsor independently.

The method of coupling a payload to a suspended payload coupler may further comprise operating a propulsion device of the lifting device and the propulsor independently.

The method of controlling a position of a suspended payload coupler may further comprise increasing or decreasing a tension in the line by operating the propulsor to generate a force with a component in a vertical direction.

The method of coupling a payload to a suspended payload coupler may further comprise increasing or decreasing a tension in the line by operating the propulsor to generate a force with a component in a vertical direction.

In an alternative embodiment a payload coupler with a position control device for controlling a position of the payload coupler when suspended from a lower end of a line for attachment at an upper end thereof to a lifting device, the payload coupler comprising:
a payload attachment means for coupling to and/or decoupling from a payload, the payload attachment means arranged to directly couple the payload coupler to a payload, and
at least one propulsor,
wherein the at least one propulsor is configured to generate a resultant propulsion force with a component perpendicular to the direction of the force of gravity.

In one embodiment of the alternative embodiment the propulsor can be realised by a single propulsor having a louvre system that can direct the flow in a desired direction. The propulsor may be oriented with a downward flow when the louvre system is not deflecting the flow.

In a second embodiment of the alternative embodiment the propulsor can be realised by a propulsor arranged on a beam providing a distance to the line and providing a pulling force pulling the line away from vertical. The propulsor may be configured with a pivot allowing it to turn in different directions for rotating the payload coupler about an axis through the line.

### BRIEF DESCRIPTION OF THE DRAWINGS

Embodiments of the invention will now be described with reference to the accompanying drawings, in which:

FIG. 1 shows a wind turbine;

FIG. 2 shows an enlarged view of the apex of a wind turbine tower;

FIG. 3 shows a payload coupler suspended from a rotorcraft;

FIG. 4 shows a payload coupler suspended from a crane;

FIG. 5 shows a payload coupler including two propulsors;

FIG. 6 is a system diagram of the payload coupler control system;

FIG. 7 is a system diagram of the lifting system control system;

FIG. 8a shows the payload coupler in a first stable position;

FIG. 8b shows the payload coupler in a second stable position;

FIG. 9 shows a schematic trajectory of a payload coupler coupling to a payload.

### DETAILED DESCRIPTION OF EMBODIMENT(S)

The term “lifting device” as used herein is intended to encompass any device suitable for providing a lifting force to suspend a payload above the ground.

The term “payload coupler” as used herein is intended to compass any device coupled to a lifting device and arranged to support a payload and control a position of the payload.

The term “payload attachment means” as used herein is intended to encompass any means of attaching a payload to a payload coupler, such as a hook, a basket, one or more magnets, which may be either permanent magnets or electromagnets, or any other suitable means for coupling a payload coupler to a payload.

Direct coupling as used herein refers to coupling between the payload coupler and the payload in the absence of intermediate features, such that the payload coupler is coupled to the payload such that movement of the payload coupler is directly transmitted to the payload and two directly coupled parts may move in a substantially unitary manner.

A stable position of a device is a position of the device that is substantially fixed, although some small movement may be expected due to weather and flight conditions. In general, a device arranged to be in a stable position will oppose displacements away from the stable position.

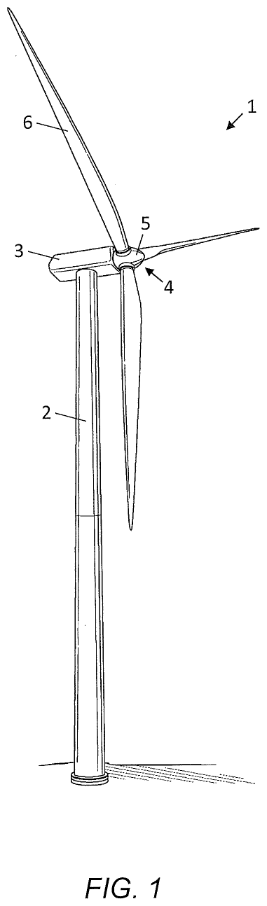

FIG. 1 shows a wind turbine 1 including a tower 2 mounted on a foundation and a nacelle 3 disposed at the apex of the tower 2. The wind turbine 1 depicted here is an onshore wind turbine such that the foundation is embedded in the ground, but the wind turbine 1 could be an offshore installation in which case the foundation may be provided by a suitable marine platform.

A rotor 4 may be operatively coupled via a gearbox to a generator housed inside the nacelle 3. The rotor 4 includes a central hub 5 and a plurality of rotor blades 6, which project outwardly from the central hub 5. It will be noted that the wind turbine 1 is the common type of horizontal axis wind turbine (HAVVT) such that the rotor 4 is mounted at the nacelle 3 to rotate about a substantially horizontal axis defined at the centre at the hub 5. While the example shown in FIG. 1 has three blades, it will be realised by the skilled person that other numbers of blades are possible.

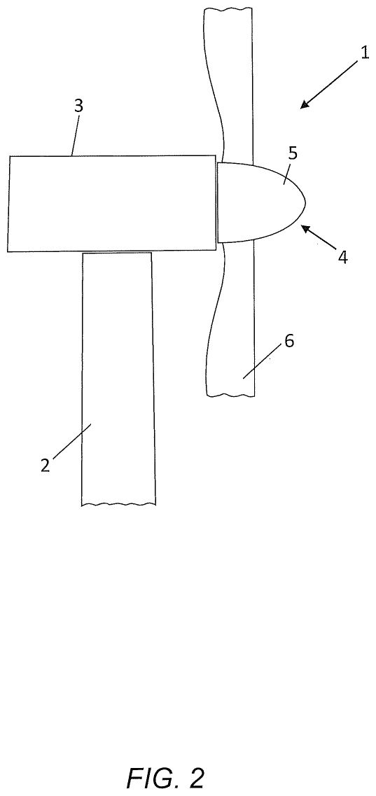

FIG. 2 shows an enlarged view of the nacelle 3 at the top of the tower 2.

The wind turbine 1 is regularly monitored during operation, in order to identify and predict the need for maintenance and/or replacement parts. This maintenance may involve a worker scaling the wind turbine to an identified location, however it is not always possible to predict the tools or components required to undertake a repair. Rotorcraft, such as drones, provide one solution that allows payloads (such as tools and components) to be delivered to a maintenance worker whilst they are in position on the wind turbine 1. However, the size of the lifting device (for example due to the size of rotorcraft propellers required to lift heavier payloads) restricts the locations accessible to the lifting device. A slung load suspended from such a lifting device would allow the lifting device to remain at a safe distance from the wind turbine and maintenance worker. However, a conventional slung load may hang freely below a lifting device, and may be unstable and/or susceptible to wind and external forces.

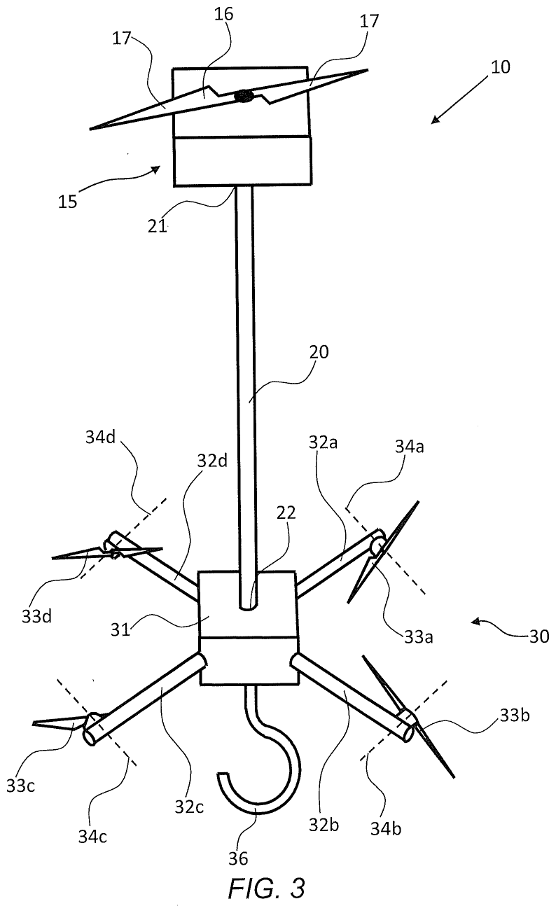

FIG. 3 shows a lifting system 10 including a lifting device 15, such as a rotorcraft. The lifting device 15 has a lifting device propulsion means 16, which in this example is a propeller 16 with a plurality of blades 17. A line 20 may be attached at an upper end 21 to the lifting device 15. The line may be a rope, cable, or other similar apparatus. The propeller 16 is operable to provide a vertical force to lift the lifting system 10 from the ground, so that the line 20 may be suspended below the lifting device 15.

A payload coupler 30 may be suspended from a lower end 22 of the line 20. The payload coupler 30 includes a main body 31 and may have four elongate members 32a,32b,32c,32d that each extend from the main body 20. Each of the elongate members 32a-d may be arranged to be oriented perpendicular to its adjacent elongate members 32a-d. In the example shown in FIG. 3, a first elongate member 32a extends from the main body 31 perpendicularly to the second elongate member 32b and fourth elongate member 32d and the second elongate member 33b extends from the main body 31 perpendicularly to the third elongate member 32c. The four elongate members 32a-d may extend perpendicularly from the axis of the line 20 when the line 20 is hanging taut under gravity so that the elongate members 32a-d lie in a plane normal to the axis of the line 20 when the line 20 is taut under gravity. This plane may be a horizontal plane.

At a distal end of each elongate member 32a-d may be a propulsor 33a,33b,33c,33d. The propulsors 33a-d may each generate a respective propulsive force along a respective propulsor axis 34a,34b,34c,34d. Each axis 34a-d may be oriented perpendicular to the axis of each corresponding elongate member 32a-d. The axes 34a-d may lie in a plane normal to the axis of the line 20 when the line 20 is taut under gravity, such that the resultant forces of the propulsors 33a-d may be in the plane normal to the axis of the line 20.

The elongate members 32a-d may provide an increased moment arm for the force generated by the propulsors 33a-d in order to increase a turning speed of the payload coupler 30.

The propulsors 33a-d may be arranged to provide translation to the payload coupler 30 to displace the payload coupler 30 relative to the lifting device 15, and may reverse their rotational direction to reverse the propulsive force generated. The propulsors 33a-d may therefore generate propulsive forces in either direction along their respective axes 34 a-d. The propulsors 33a-d may allow the payload coupler 30 to move in an arc relative to the lifting device by providing a resultant force in any horizontal direction or any direction in a plane perpendicular to the line 20. The arc radius may be given by the length of the line 20 between the lifting device 15 and the payload coupler 30. The propulsors 33a-d may also be arranged to provide rotation to the payload coupler 30 in a clockwise or anti-clockwise direction about an axis along the line 20. The propulsors 33a-d may generate forces in order to provide a translational and/or rotational resultant force in a plane normal to the axis of the line 20.

The propulsors 33a-d may be rotatable about axes along their respective elongate members 32a-d, such that their respective axes of propulsion 34a-d may have varying vertical components.

A payload attachment means 36 may be attached underneath the main body 31 of the payload coupler 30. The payload attachment means 36 is configured to attach to a payload. The payload may be a tool or component that is required for maintenance of a wind turbine 1. The lifting system 10 may be operable to lift the payload above the ground, such that the payload coupler 30 and payload are suspended on the line 20.

The lifting system 10 may then be moved to a specified location, for example proximate a wind turbine 1.

The line 20 may be a flexible line, and so the payload coupler 30 may be effectively a slung load from the lifting device 15 that is able to swing relative to the lifting device 15. The movement of the lifting device 15 may result in unwanted and/or unstable forces being applied to the payload coupler, and/or the payload coupler 30 may be affected by wind and weather conditions.

The payload coupler 30 may be able to move independently from the lifting device 15. The resultant forces of the propulsors 33a-d may be controlled to stabilise the movement of the payload coupler 30, such that the payload coupler 30 may be maintained in a stable position relative to the lifting device 15 when the lifting device 15 is moving. Alternatively, the resultant force of the propulsors 33a-d may be controlled to stabilise the movement of the payload coupler 30 in a stable position relative to a fixed structure, such as a wind turbine 1.

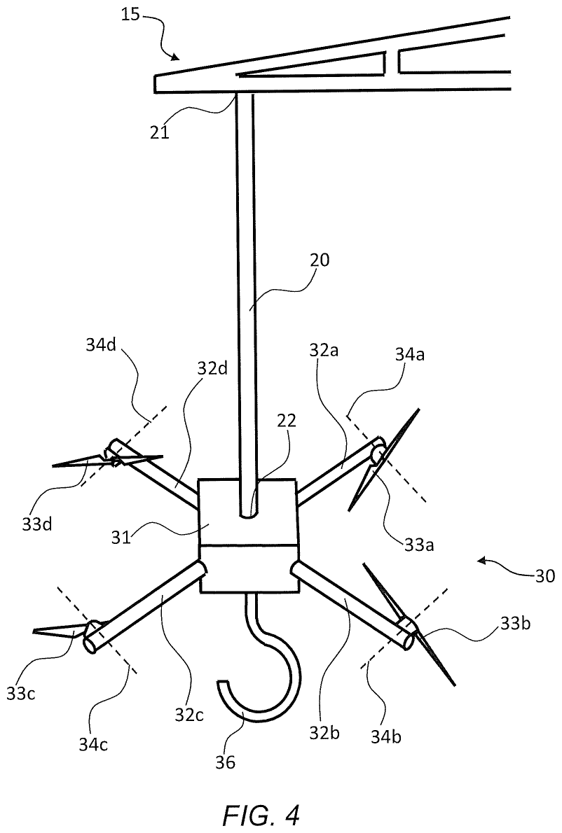

FIG. 4 shows a further example of the lifting system similar to the first example, except that in this example the upper end 21 of the line 20 is attached to a ground-based lifting device, such as a crane. The payload coupler 30 may be the same as described in relation to the first example, such that it can provide autonomous translation and rotation relative to the lifting device 15. In the case of a ground-based lifting device, such as a crane, the lifting device may have a mains power source.

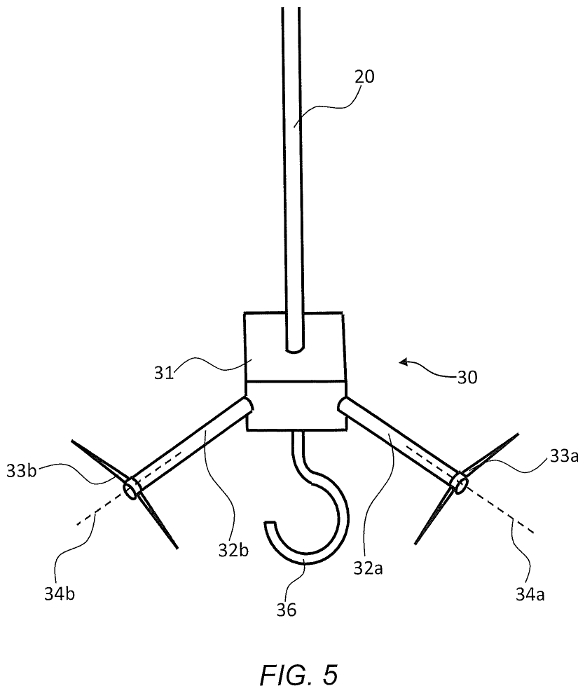

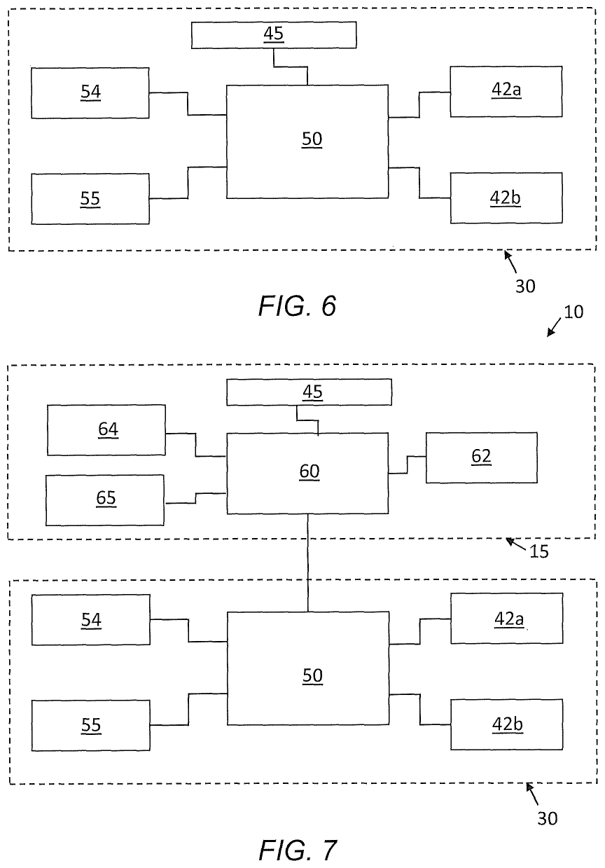

FIG. 5 shows a further example of a payload coupler 30. The payload coupler may be similar to the previous examples shown in FIGS. 3 and 4, except that the payload coupler 30 of FIG. 5 has only two propulsors 33a,33b. The propulsors 33a,33b may be oriented perpendicularly to each other. The payload coupler 30 may thereby be able to translate in any direction by controlling the force generated by each propulsor 33a,33b, and thereby counteract destabilising forces acting upon the payload coupler 30. The axis of each propulsor 33a,33b may be parallel with the axis of each corresponding elongate member 32a,33b such that the force generated by each propulsor 33a,33b may act through the axis of the line 20. FIG. 6 is a system diagram of the payload coupler 30. The system includes a controller 50, which may be powered by a power source 45, such as a battery. The system may include a position sensor 54 and/or a movement sensor 55. The position sensor 54 may be connected to the control system 50 and configured to record and/or transmit information to the control system 50 concerning the position of the payload coupler 30. This information may be used by the controller 50 to determine how to drive propulsor motors 42a,43b and thus how to move the payload coupler 30 to a target location. The movement sensor 55 may be connected to the control system 50 and may be configured to record and/or transmit information to the control system 50 upon movement of the payload coupler 30. This information may be used by the controller 50 to control the propulsor motors 42a,43b to oppose movement of the payload coupler 30. The propulsors 33a,33b may be operated independently by the control system 50 to generate a required resultant force.

In the example of FIG. 6 the payload coupler 30 is shown to include only two propulsor motors 42a,42b, wherein the propulsor motors 42a,43b are connected to respective propulsors 33a,33b. In an alternative example the payload coupler 30 may have more or fewer propulsors 33 with corresponding propulsor motors 42, for example the payload coupler 30 may have three propulsors 33, four propulsors 33, or any other suitable number of propulsors 33.

The lifting device 15 may have a lifting device control system 60. The lifting device control system 60 may be powered by a power source 45, such as a battery. The lifting device control system 60 may be connected to a position sensor 64 and/or a movement sensor 65, and each may feed information to the lifting device control system 60 on the position and/or movement of the lifting device 15 respectively. This information may be used to control a propeller motor 62 connected to propeller 16.

The position sensor(s) may be any suitable movement sensor(s) and may include one or more of a GPS device, a proximity sensor, an inclinometer, or any other suitable position sensor known in the art. The movement sensor(s) may be accelerometer(s), gyroscope(s), jerkmeters or any other suitable movement sensor known in the art. The payload coupler control system 50 may be linked to the lifting device control system 60, as shown in FIG. 7. The lifting device control system 60 and payload coupler control system 50 may have a master-slave relationship. The payload coupler control system 50 may be the master system and the lifting device control system 60 may be the slave system. The payload coupler control system 50 may thereby control movement of the lifting device 15. In this case, the payload coupler 30 may move relative to the lifting device according to the directions of the payload coupler control system 50, whilst the lifting device 15 may maintain its position until instructed to move to a different position by the payload coupler control system 50. In an alternative example, the payload coupler control system 50 may be the slave system and the lifting device control system 60 may be the master system. The lifting device control system 60 may thereby control movement of the lifting device 15 and the payload coupler 30. In a further example, the payload coupler control system 50 may be the master system during coupling/uncoupling operations and reconfigure to slave system during transit between locations for performing the coupling/uncoupling operation and the lifting device control system 60 may reconfigure between slave and master accordingly.

The lifting device 15 and payload coupler 30 may have the same power source 45 and power may be transmitted from the lifting device 15 to the payload coupler 30 via the line 20 or via a separate cable. Alternatively, the lifting device 15 may have a first power source 45 and the payload coupler may have a second power source 45.

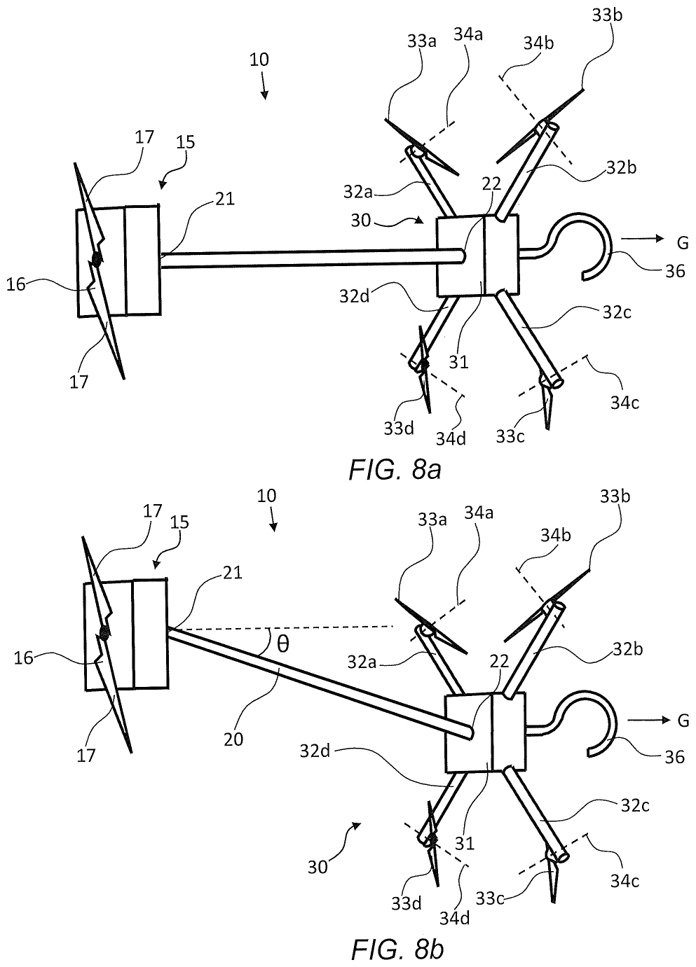

The propulsors 33a-d on the payload coupler 30 may allow the payload coupler 30 to move relative to the lifting device 15. FIG. 8a shows the payload coupler 30 suspended vertically from the lifting device 15 in a first position, such that the line 20 is vertical and the payload coupler 30 is hanging under gravity (denoted by arrow G). The resultant forces of the propulsors 33a-d may be controlled to stabilise the movement of the payload coupler 30 in the first position relative to the lifting device 15. A payload may be coupled to the payload attachment means 36 of the payload coupler 30 at the first position.

It may be desirable to move the payload coupler 30 (and a payload if it is attached to the payload attachment means 36) to a second position. This may be achieved by controlling the propulsors 33a-d to generate a force to move the payload coupler 30 relative to the lifting device 15. For example, FIG. 8b shows the payload coupler 30 in a second position such that the line 20 is inclined at an angle 6 to the vertical direction.

It will be apparent that the line 20 in the first and/or second position may be vertical or may be inclined at an angle, and that a payload may be coupled to or decoupled from the payload attachment means 36 at the first and/or second positions. For example, a payload may be attached to the payload attachment means 36 at a first position, and transported to a second position, by movement of the payload coupler 30 and/or of the lifting device 15, where it may be decoupled. The payload coupler 30 may remain at the second position, move back to the first position, or move to a third position.

Providing a payload coupler 30 that is able to move independently relative to a lifting device 15 may allow tools and/or components to be delivered to a target location quickly and safely. The lifting device 15 may be configured to provide a lifting force sufficient to lift the lifting system 10 and the payload. The lifting device 15 may be configured to provide a significant portion of the lifting force required to lift the lifting system 10 and a payload, for example more than half of the total weight of the lifting system 10 and a payload. The lifting device 15 may therefore have a large propeller 16 that is not safe to operate in close proximity to maintenance personnel, a wind turbine 1, a nacelle 3 of a wind turbine 1, or similar structure. The payload coupler 30 may provide a delivery system that can move relative to the lifting device to deliver a payload without being required to generate a significant lifting force. The payload coupler 30 may be able to reach locations that are inaccessible to a lifting device 15.

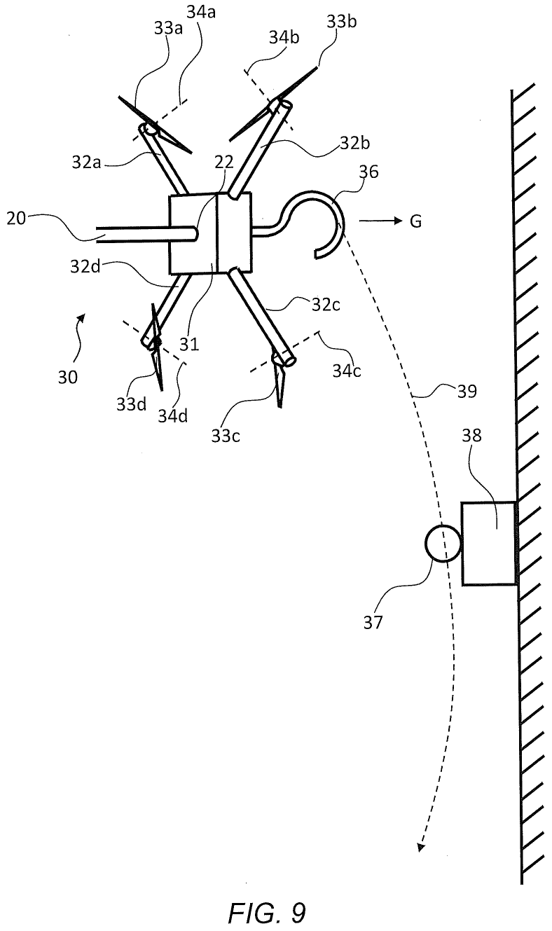

The payload coupler 30 may be operable to couple the payload attachment means 36 to a corresponding payload connecting means 37 on a payload 38. As shown in FIG. 9, the propulsors 33a-d may generate a propulsive force to move the payload coupler 30 along a predetermined path 39 such that the payload attachment means 36 couples to a corresponding connecting means 37 on a payload 38.

As the payload coupler 30 moves along the predetermined path 39, the lifting device 15 may maintain its position, or move correspondingly with the payload coupler, or move independently of the payload coupler 30. The resultant forces of the propulsors 33a-d may be controlled to stabilise the movement of the payload coupler 30 as the payload coupler 30 travels along the predetermined path 39.

When moving, the payload attachment means 36 may couple to the corresponding connecting means 37 on the payload 38 by the payload attachment means 36 being a hook which is threaded through a loop, which is the connecting means 37 or the payload attachment means 36 and the connecting means 37 may be magnets which are moved into close proximity so that their attractive forces directly couple the payload 38 to the payload coupler 30.

The payload coupler 30 may be free to rotate relative to the line 20. In an alternative example, the payload coupler 30 may be inflexibly coupled to the line 20, such that rotation of the payload coupler 30 causes a corresponding rotation and/or twisting of the line 20.

The propulsors 33a-d may be ducted or un-ducted fans. The propulsors 33a-d may be electric fans or pump-jet propulsors, or any other suitable propulsor known in the art. The propulsors 33a-d may be fixed relative to the payload coupler 30. Alternatively, the propulsors 33a-d may be moveable relative to the payload coupler 30 such that their thrust vectors can change direction. The propulsors 33a-d may be coupled directly to the main body 31 of the payload coupler 30, such that propulsors 33a-d are not coupled to the ends of elongate members 32.

The propulsors 33a-d may have a resultant force in a plane normal to the line 20. In alternative examples, the propulsors 33a-d may be operable to generate a force having a component parallel to the line 20. The propulsors 33a-d may be operable to generate a force having a vertical component directed upwards, for example to lift the payload coupler 30 in relation to the payload attachment means 36. This may improve coupling of the payload attachment means 36 to the payload connecting means 37 or may reduce the tension in the line 20.

The propulsors 33a-d may be oriented to provide a force component parallel to the line 20 such that the tension in the line is increased or decreased. A force component parallel to the line 20 that increases tension in the line 20 (i.e. a vertically downwards component) may increase the stability of the payload coupler 30 and payload 38, for example during windy conditions.

There may be only one line 20 coupled between the lifting device 15 and the payload coupler 30 or may be two or more lines 20. The line 20 may be substantially inflexible. The line 20 may have a length between 5m and 10m. The line 20 may be inextensible. The line 20 may be coupled to a pulley or winch system within the lifting device 15 or within the payload coupler 30, which may allow the length of the line 20 between the lifting device 15 and payload coupler 30 to be varied.

The payload attachment means 36 may be fixed relative to the payload coupler 30. Alternatively the payload attachment means 36 may be able to rotate relative to the payload coupler 30 and/or provide some translation relative to the payload coupler 30. Although the invention has been described above with reference to one or more preferred embodiments, it will be appreciated that various changes or modifications may be made without departing from the scope of the invention as defined in the appended claims.

1. A payload coupler with a position control device for controlling a position of the payload coupler when suspended from a lower end of a line for attachment at an upper end thereof to a lifting device, the payload coupler comprising:
a payload attachment means for coupling to and/or decoupling from a payload, the payload attachment means arranged to directly couple the payload coupler to a payload, and
at least two propulsors,
wherein the at least two propulsors are each configured to generate resultant propulsion forces which are non-parallel, each resultant force having at least a component perpendicular to the axis of the line when the line is hanging taut under gravity.

2. The payload coupler of claim 1, wherein the components of the resultant propulsion forces perpendicular to the axis of the line when the line is hanging taut under gravity are orthogonal.

3. The payload coupler of claim 1, wherein the propulsors are each selectively operable to generate resultant propulsion forces in two opposite directions.

4. The payload coupler of claim 1, wherein the propulsors are first propulsors and the payload coupler further comprises two second propulsors, each second propulsor configured to generate a resultant propulsion force parallel to a resultant force generated by a respective one of the first propulsors, the respective first and second propulsors being spaced apart in a direction perpendicular to their respective resultant force.

5. The payload coupler of claim 1, wherein the propulsors are arranged to generate a resultant force perpendicular to the axis of the line when the line is hanging taut under gravity.

6. The payload coupler of claim 1, wherein the propulsors are arranged to generate a force having a component parallel to the axis of the line when the line is hanging taut under gravity.

7. The payload coupler of claim 1 any preceding claim, further comprising a movement sensor and a control system, the control system being coupled to the movement sensor and the propulsors, and
wherein the control system is arranged to drive the propulsors to oppose movement of the device detected by the movement sensor.

8. The payload coupler of claim 1, further comprising a position sensor and a control system, the control system being coupled to the position sensor and the propulsors, and
wherein the control system is arranged to drive the propulsors to move the device to a target location.

9. A lifting system comprising:
a line,
the payload coupler of claim 1, the payload coupler coupled to the lower end of the line, and
a lifting device coupled to the upper end of the line, the lifting device having a lifting device propulsion means for moving the lifting device.

10. The lifting system of claim 9, wherein the lifting device propulsion means is operable independently of the propulsors.

11. The lifting system of claim 9, wherein the lifting device comprises a power source arranged to provide power to the payload coupler.

12. A method of controlling a position of a suspended payload coupler, the method comprising:
providing a payload coupler suspended from a lower end of a line which is coupled at its upper end to a lifting device, the payload coupler having a propulsor configured to generate a resultant propulsion force having at least a component perpendicular to the axis of the line when the line is hanging taut under gravity,
operating the propulsor to generate a propulsive force to maintain the payload coupler in a first stable position or to move the payload coupler along a predetermined path; and
coupling a payload to the payload coupler or decoupling a payload from the payload coupler while the payload coupler is maintained in the first stable position or moved along the predetermined path.

13. The method of claim 12, further comprising operating the propulsor to generate a propulsive force in order to move the payload coupler to a second stable position different from the first stable position.

14. The method of claim 12, wherein the line is substantially vertical when the payload coupler is in the first stable position and/or the second stable position.

15. The method of claim 12, wherein the line is not vertical when the payload coupler is in the first stable position and/or the second stable position.

16. The method of claim 13, further comprising coupling the payload to the payload coupler or decoupling the payload from the payload coupler while the payload coupler is in the second stable position.

17. The method of claim 12, wherein the payload is coupled to or decoupled from the payload coupler by movement along the predetermined path.

18. The method of claim 12, further comprising operating a propulsion device of the lifting device and the propulsor independently.

19. The method of claim 12, further comprising increasing or decreasing a tension in the line by operating the propulsor to generate a force with a component in a vertical direction.
